(19) United States
(12) Patent Application Publication
(10) Pub. No.: US 2017/0072288 A1
(43) Pub. Date: Mar. 16, 2017

(54) APPARATUS AND METHOD FOR FLATTENING AND LASER ENGRAVING SKIS

(71) Applicant: Grace Skis, Gypsum, CO (US)

(72) Inventors: Andrew J. Rouse, Avon, CO (US); Patrick van den Broek, Golden, CO (US)

(21) Appl. No.: 14/849,807

(22) Filed: Sep. 10, 2015

(51) Int. Cl. A63C 5/12; B23K 26/60; B44C 1/22

(52) U.S. Cl. CPC A63C 5/12; B44C 1/228; B23K 26/60; B23K 2203/36

(57) ABSTRACT

The invention relates to an apparatus for flattening the top surface of skis to facilitate laser engraving thereof, to the method of laser engraving of skis employing such apparatus, and to a custom laser-engraved ski production and inventory management system wherein blank skis are manufactured, defects culled, and the blank ski of suitable length etc. is matched to the customer and laser engraved, preferably using the disclosed flattening apparatus.

### BACKGROUND OF THE INVENTION

Field of the Invention

The present invention relates to apparatus and methods for laser engraving of skis.

Description of the Background Art

The personalization of skis with artwork is popular. The artwork can be applied in the form of stickers, or it can be engraved upon the ski. Petutschnigg, et al., “Laser Treatment of Wood Surfaces for Ski Cores: An Experimental Parameter Study”, Adv. Mat. Sci. Eng'g, Vol. 2013, Article ID 123085, pp. 1-7 (2013) discusses the laser engraving of various woods used in ski production.

Skis are typically laminates, and the top sheet may be laser engraved, and then the layers glued, pressed and shaped. See for example Deacon, “Designer Carves Fat-Ski Niche,” The Press [Christchuch, New Zealand], page E4 (12 Aug. 2008), under “Making the Skis”, where step 6 is applying the topsheet graphic and steps 7-9 are setting out the layers, “build[ing] the ski like a sandwich,” and putting the whole ski into a press. However, since the ski is customized from the moment the graphic is applied to the topsheet, if there is a failure at any later point in the building, finishing or tuning process, the ski is wasted. Such failures may be attributable to something as simple as misalignment of the custom top sheet.

One of the problems with laser engraving of the top sheet is that for accurate transfer of the design, the sheet must be flat. Hence, the invention relates in part to a flattening jig for skis.

Miller, US 2010/0213180 describes a jig for a laser engraving machine. It does not specifically refer to laser engraving of a ski or similar article. There is a housing (defining a chamber including a vertically adjustable table), a jig 22 (comprising article support or base 28 and light support 30), a light source for projecting a point of reference alignment indicator onto the article support, and a laser-emitting engraving device. The base 28 is placed between the front and rear fences on the table.

According to para [0031], “Jig 22 further includes a plurality of retaining members 76 for retaining or securing an article 78 to be engraved on jig 22.” As depicted in FIG. 2, these retaining members slide in slots that are x-x or y-y direction, with z direction being vertical, and designed to deliver pressure against the *edge* of the article, via planar face 82. See the supporting description near the end of para [0031]. Thus, the article, which is of a more or less rectangular shape, is kept from sliding horizontally, but it is not flattened.

Another embodiment, discussed in para [0036] and FIG. 10-11, is intended for retention of an article that is “irregularly shaped” (in plain view). The article is in essence placed over sticky substance 320 so it is held in place. Again, this deals with horizontal sliding, but not flattening.

Hahn (Nariya) WO 2014/36008 discloses a laser etching system. Jigs for improved holding and position are broadly discussed in para [0030]. Para [0031] also refers to a tray adapter 114 for holding and positioning objects. Para [0034] says that the adapter tra is shaped to accept an object. Details are minimal and there is certainly no teaching of flattening.

CN200984866 refers to a “rotation clamp” for a turntable device. It is not believed to include a function for flattening an article that is not already flat.

Clark, U.S. Pat. No. 8,469,343 is directed to an “adjustable track clamp”. This is a simple clamp for securing a workpiece to a workbench. The clamp engages a track on the workbench. The most interesting aspect is that “spacer block assemblies 400 hold workpiece 110 parallel to track 110A” and “spacer block assemblies 400 are adjustable to account for different workpiece thicknesses.” There is a distinction between holding elements that are of different thickness in order to engage a variable height article and holding elements that actually flatten an article that curves up or down. It is also taught that the clamp mechanism may provide different clamping locations relative to the position of clamping block 306. Again, we must distinguish between merely providing different clamping locations, to prevent horizontal shifting, and providing actual flattening.

Townsend, U.S. Pat. No. 4,170,345 describes a holding clamp assembly. This is composed of sliding clamps that presents vertical planar holding faces like those in the first reference. This does not have flattening capability.

Campbell U.S. Pat. No. 4,066,250 presents a ski clamping apparatus for holding the ski while sharpening or waxing it. Note that for that usage, it is not important (and indeed might be undesirable) to flatten the ski. The clamps are attached to a support. As best seen in FIGS. 1 and 2, the clamps support the ski at longitudinally spaced points that are away from both the center and the tips. The clamps hold the ski at the longitudinal edges. see col. 1 line 29-48. While the clamps are moveable longitudinally along the ski, there is no teaching of flattening. It appears from e.g. FIG. 3 that there is equal pressure above and below the ski from the clamp, so it is held in place but not flattened.

Dittmar, U.S. Pat. No. 5,211,517 discloses a machine for making microgrooves in the metal edge inserts typically found on the undersurface of snow ski. Background states that the machine can cut skis that are not flat until mounted and flattened on the machine. The ski is mounted on platten 10, with the ski undersurface face-to-face with the platten undersurface. There are mounting clamps on the ends of the platten, and a plurality of flattening support clamps 23 in-between. All of the clamps are on the undersurface of the platten, and they may be sliding Jorgensen clamps. Dittmar's clamping system does not flatten the top of the ski.

Smialek, U.S. Pat. No. 4,939,873 describes a ski grinding device, and in particular a device for holding the snow ski while the bottom and edges are ground. The ski is placed on a true straight edge and clamped thereto. More particularly, an adjustable frame is mounted on the ski and individually adjustable biasing legs extending from the frame apply pressure to the top of the ski. The point, thus, is to flatten the bottom, not the top, of the ski.

Schmutzler, U.S. Pat. No. 3,662,467 teaches a pantograph engraving apparatus. The document teaches that simple workpiece vise clamps are not suitable for holding a non-rectangular article such as a ski, because the ski varies in width along its length. Hence, it provides for a pair of vise jaws which are each pivotable about a vertical axis. However, there is no reference to flattening the article, only to fixing (clamping) it in position.

Eveland U.S. Pat. No. 5,504,301 discloses a laser engraving apparatus, and discusses various ways of clamping a mask to a workpiece (the mask limiting the engraving to certain areas). Reference is made for example to the use of “uniformly distributed” magnets on one side of the workpiece in conjunction with a mask made of a ferrous material, to use of screw-jacks, and to use of suction (partial vacuum).

Rosenberger, US20140265714 mentions laser engraving of sports board as well as urethane sealing. Willis, US20140375009 mentions laser engraving of a skateboard. Chai, US 20110174788, Costin U.S. Pat. No. 8,529,775 and Macken, U.S. Pat. No. 4,480,169 relate more broadly to laser engraving. Kashwa, U.S. Pat. No. 4,858,945 relates laser cutting and edge welding of ski blanks from steel. Vasselin, U.S. Pat. No. 5,616,418 teaches use of urethane film on water ski.

The ski flattening system of the present invention may be used as part of a larger method for rapidly providing a custom decorated ski.

Peterson, “Grace Skis”, ColoradoBiz (January 2015),

http://search.proquest.com/professional/docview/1650439677?accountid=157282 [Retrieved from ProQuest Dialog on Apr. 30, 2015] notes that Grace Skis provides skis in a “wide range of shapes and sizes,” and “the wooden veneers are laser-engraved.” It does not disclose making an inventory of complete skis (laminates) first, then pick the best match for the customer from that inventory, and then laser engraving, to reduce the time from order to shipment.

Nor is this combination of steps taught elsewhere in the art. According to Ruuttu US20040236634, the customer chooses type or even shape of ski and it is assembled to suit, with laser printing o image possible. It differs from our invention 1 in that we make a set of diversely sized ski blanks first, then pick from the set to match and engrave.

Fonte, US 20150055086 teaches online specification of a custom product, including decoration. However, it appears that all manufacturing is done after this specification, rather than using the specification to choose from inventory and then adding custom decoration.

Sylvain, U.S. Pat. No. 8,104,784 relates to horizontal laminated ski production. At col 4, In 17-29 it is stated that the individual layers are prepared to differing lengths.

### SUMMARY OF THE INVENTION

The invention relates to apparatus used to prepare a ski(s) for laser engraving, and to the laser engraving method using that apparatus.

The flattening jig of the present invention comprises a bed for resting a ski or pair of skis, at least two flattening brackets for applying a downward force for flattening portions of the ski, and at least one pair of tracks in or on said bed for slidably positioning the brackets at different points along the length of the skis.

It is further contemplated to offer a flattening kit, which comprises said flattening jig, and one or more lifting shims, whose positions along the length of the ski can be adjusted as needed, for applying an upward force for flattening portions of the ski.

It is further contemplated to offer a laser engraving apparatus that comprises a flattening table on which said flattening jig is moved in a controlled manner, and a laser engraver device for engraving a flattened ski mounted in said flattening jig as it passes along said flattening table.

A laser needs a flat surface to burn a graphic that does not vary in color or depth of the burn. Too shallow and it's too light and too deep and it cuts all the way through the top sheet the graphic is applied to and into the underlying layers. A laser must be focused and this requires a constant imaging plane, which our jug turns a ski by clamping it so it is flat on top. Skis vary in thickness, being thickest at the center and thinnest at the ends, so it is not possible to clamp a ski so it is flat throughout both on top and on bottom.

Thus, the invention relates in part to laser engraving a ski in a process comprising placing the blank laminated ski in an apparatus (combination of flattening jig and lifting shims) that holds and flattens the top surface of the ski, including the up- or downturned tips and tails, so that even the tips and tails may be accurately engraved.

This laser engraving process may be used as part of a large ski manufacturing management process. Conventionally, when a custom decorated ski is ordered, the customer must wait for the ski to be built from scratch. The top sheet comes in rolls that are cut and flattened and, while flat, laser engraved, and then laminated with the other layers and rocker and camber applied.

Thanks to the present invention, instead of laser engraving a veneer top sheet for a ski, and then building the ski, the entire ski may be built first, with a blank top, and then laser engraving applied to the ski, the ski being flattened by the flattening jig.

It may be advantageous to produce blank skis in a plurality of sizes and shapes, discarding any defective skis, to create an inventory of high quality skis in a plurality of sizes and shapes. If an order is received for a custom engraved ski, a blank ski that is sufficiently close in size and shape to that ordered may be selected, flattened, and laser engraved with the custom design. This practice is expected to reduce the turnaround time for a ski with a custom graphic from a couple of months to a couple of days.

Hence, the invention also relates to an production and inventory management system for skis which relates to such production and quality control of blank skis, and post-manufacture laser engraving thereof. Thus, this system comprises a) manufacturing blank skis in a plurality of sizes, so dimensioned so that most customers interested in customized skis would find a suitable size, and eliminating any defective blanks; b) laser engraving the topsheet (e.g. bamboo veneer) of the ski, and c) sealing the ski (e.g urethane sealant).

This is distinct from the normal procedure, in which decoration is added to the topsheet (a wood veneer) of the ski before it laminated (glued and pressed) with the lower layers. There is a risk that a defect (e.g., misalignment) will arise during this lamination process. Failure rates of close to 30% are not unusual.

### BRIEF DESCRIPTION OF THE DRAWINGS

FIGS. 1A and 1B present an overhead view of one embodiment of the flattening jig with lifting shims. A pair of skis 1 rest on base 2. The skis 1 are placed so that on one side they are in contact with alignment rib 8, which is the centerline of the bed. Lifting shims 3 are placed under skis 1 to exert a localized upward force thereon. Flattening brackets 4 are placed over skis 1 to exert a localized downward force thereon. The flattening brackets 4 slidably engage tracks 5 mounted on the base 1, whereby their longitudinal position can be adjusted. Thus in FIG. 1A, the skis 1 are shorter than in FIG. 1B, and consequently one of the flattening brackets 4 has been repositioned to accommodate.

FIG. 2 shows that in some embodiments, the bracket 4 is also pivotably mounted on the track, so that it may be swung out of the way rather than press down on the skis.

FIG. 3 is a profile view, showing skis 1 resting on the base 2, and the latter on a portion of the flattening table 10. The flattening brackets 4 are mounted in tracks (not shown) on the base 2, holding down the skis 1, and the lifting shims 3 are underneath the skis 1. The location of the laser beam 6 from laser engraver 7 is shown is shown.

FIGS. 4A, 4B and 4C are overhead views showing the complete system, comprising laser engraver 7 and flattening table 10. The base 2 rests on the flattening table 10. The skis 1 are retained on the base by brackets 4 in tracks 5; no shims are visible. In FIG. 4A, the base 2 is in the starting position; in 4B, it has passed partly underneath and past the laser engraver 7; and in 4C it has emerged on the far side of the laser engraver 7, and it can be seen that the decorative material 9 has been engraved on the upper surfaces of the skis 1.

FIG. 5 is an end view of the flattening jig. It is provided to more clearly show the alignment rib 8.

### DETAILED DESCRIPTION OF THE PREFERRED EMBODIMENTS OF THE INVENTION

Ski lengths are related to skier height, and range approximately from 115 cm to 200 cm. The ski width varies along the length of a ski, and the maximum width varies from ski to ski, typically ranging from 60-150 mm. Ski length and width depend both on the skier's height and weight, and on considerations of skiing performance.

Generally, skis are not flat. First, in general, the tips of the ski are turned upward (“tip rise”). However, if a substantial part of the ski is turned upward that is called rocker. There can be front rocker (“early rise”), rear rocker, or the combination of the two. Should it be necessary to distinguish between early rise and front rocker, we will say arbitrarily that if more than 5% of the length of the ski from the tip (front end) is turned upward, then this is front rocker Likewise, if more than 5% of the length of the ski from the tail (rear end) is turned upward, than this is rear rocker.

Rocker may be quantified by two numbers, the first being the maximum amount of tip rise and the second being the distance along the ski edge to the closest contact point (the place the unweighted ski will touch a horizontal surface that it is rested upon). An alternative method would be the horizontal distance from the point on the rest surface immediately underneath the tip to the closest contact point. The latter method is preferred.

Camber refers to the center of the ski being convex upward when the ski is unweighted, i.e., is not carrying a skier. Some authorities instead use the term “positive camber,” and the center of the ski being flat is then called “zero camber” or “flat camber”.

Camber may be measured as the vertical height of the longitudinal center of an unweighted ski from the surface that it rests upon. One may also measure the horizontal distance between the two contact points. See dspace.mit.edu/handle/1721.1/45290.

If camber exists, then the unweighted ski resting on a flat horizontal surface contacts that surface at only two points, and the longitudinal profile of the ski at those points is convex downward. If there is rocker as well as camber, then those two support points are closer together.

When the skier turns, the ski is bent in the opposite direction to that of the camber, and thus the pent-up elastic energy of the camber helps the skier snap out of the turn. The amount of rocker influences how the ski performs in a variety of snow conditions. For example, in powder you want more tip (front) rocker to make the ski float more and more tail (rear) rocker makes the ski surf in deep snow.

Unfortunately, the presence of camber and/or rocker complicates the process of decorating the ski by laser engraving. For the design to be accurately engraved, the upper surface of the ski must be held flat and horizontal. Any bend in the ski will distort the image in the vicinity of the bend.

In order to ensure accurate transfer of the desired image to the upper surface of the ski by laser engraving, the ski is held in a flattening jig that holds substantially flat at least that portion of the ski which is to be engraved.

The flattening jig comprises a base 2, two or more flattening brackets 4, and one or more tracks 5 for slidably positioning the flattening brackets at desired positions along the length of the skis. As previously noted, the jig may be used in conjunction with one or more lifting shims 3.

The base (bed) 2 will preferably be of sufficient width to accommodate two skis simultaneously, as skis are sold and used in pairs. Preferably, the base 2 is of sufficient length to accommodate the longest skis sold. But if desired, one may have more than one length of flattening jig, each length being suitable for holding skis of a particular range of lengths. The bed may be of any suitable material, but pressboard is preferred.

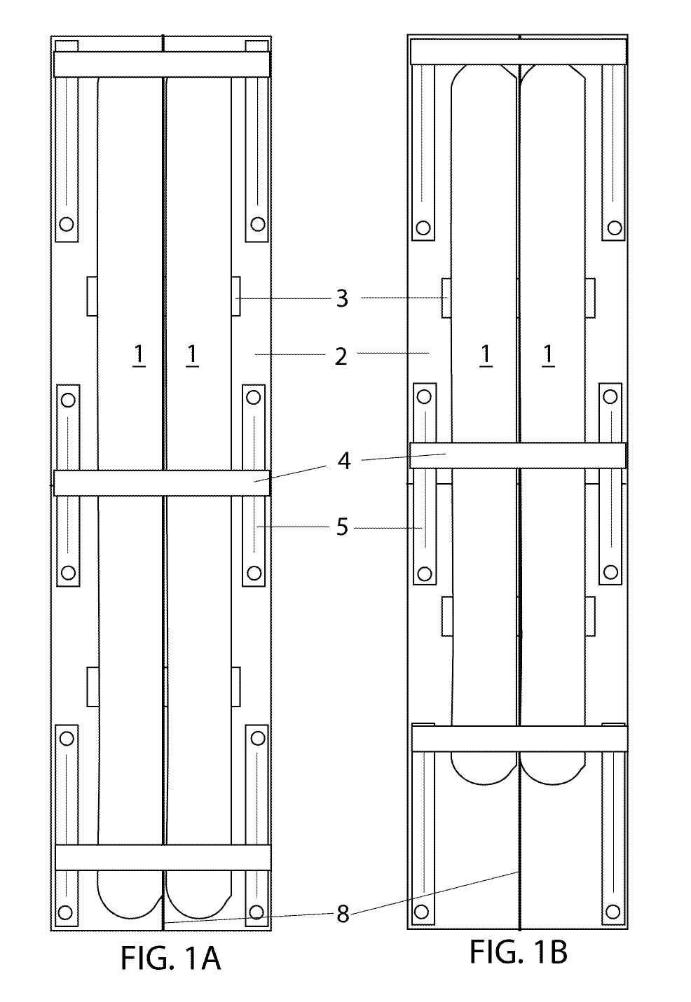

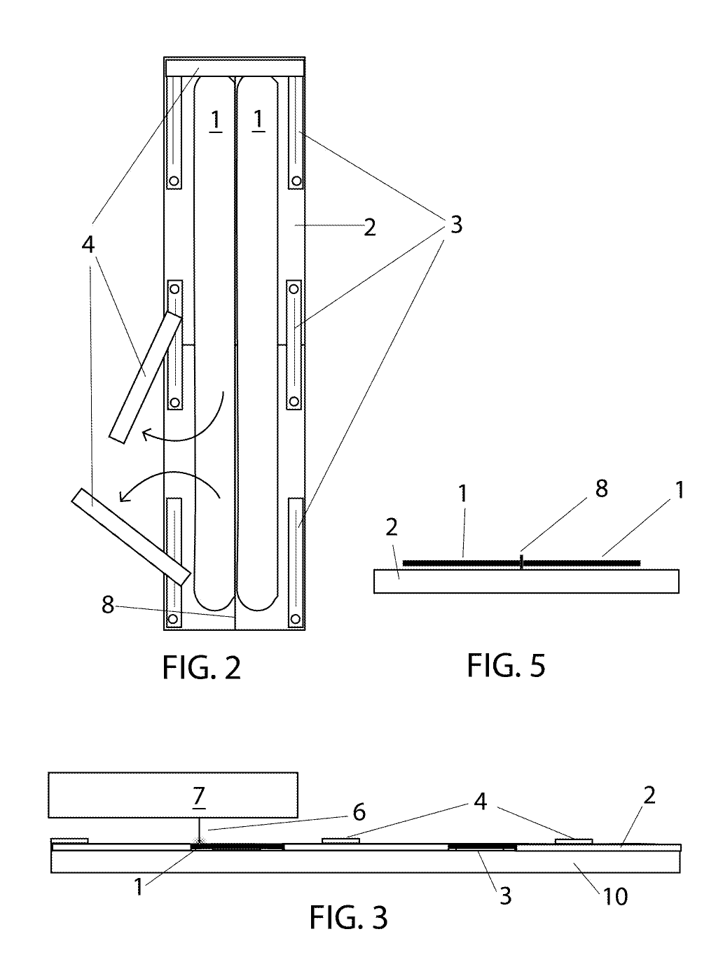

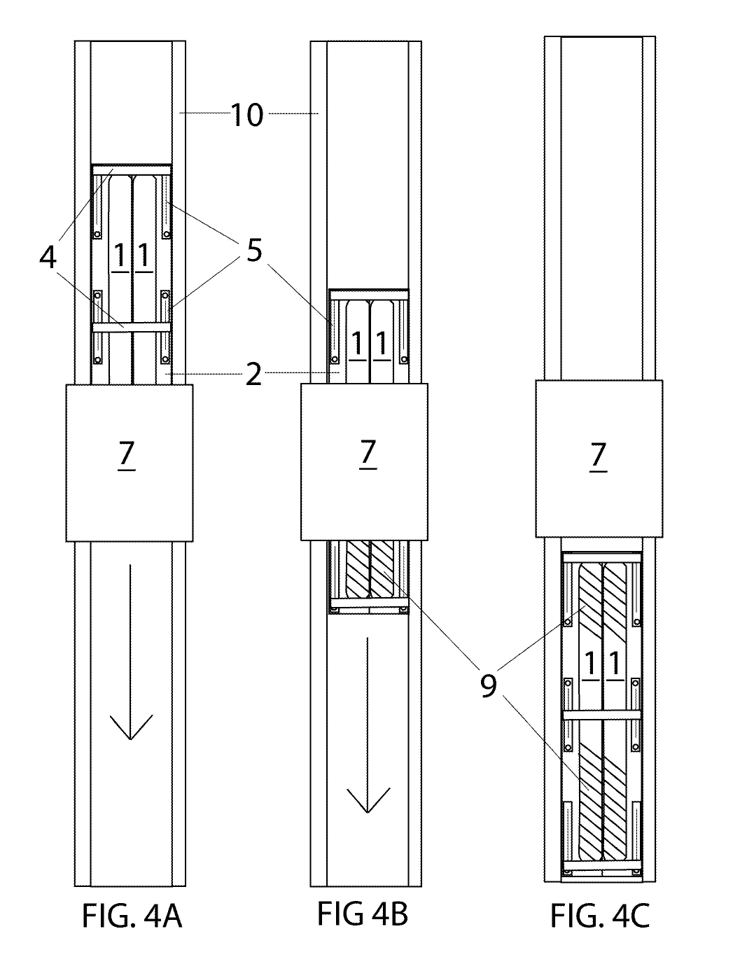

The base 2 provides at least one track 5, but more preferably at least one pair of tracks 5 in which the lifting brackets 4 can be positioned, each lifting bracket 4 slidably engaging two tracks. In one embodiment (not shown in the figures), there is a single long pair of tracks 5, and all lifting brackets 4 slide along the same pair. In another embodiment, depicted FIG. 1, there are several pairs of shorter tracks 5, each dedicated to a single flattening bracket 4. And of course intermediate combinations are possible.

Since, in general, skis curve upward toward the tips, it is desirable to provide at least two flattening brackets 4, one for each end. If the ski 1 has positive camber, that is, is convex upward at the center, then it is desirable to provide at least a third flattening bracket 4 to position over the center.

The flattening brackets 4 must of course span the transverse distance between the two tracks that they engage with, and of course the distance between the two slots must be sufficient to accommodate at least one ski 1 and more preferably a pair of skis 1, so that a pair of skis may be flattened simultaneously.

The width of a ski varies along its length, and for choosing the spacing of the tracks, it is the maximum width of the ski that is relevant. Skis typically have a maximum width of 138 mm to 155 mm, and thus the preferred track separation (center to center) if both skis of a pair are to be engraved in the same run, is 320 to 360 mm (12.60 to 14.17 inches).

In some embodiments, each flattening bracket 4 runs from track 5 to track 5, and thus has a length equal to or slightly greater than the track separation. In other embodiments, each flattening bracket 4 slides along a single track 5, and thus has a length equal to about half, or somewhat less, of the track separation. In that event, in use, the bracket 4 on one track 5 may be placed opposite another bracket 4 on the other track 5, to act at essentially the same longitudinal position on the ski. Alternatively, the brackets 4 may be staggered longitudinally.

The width of the flattening bracket 4, i.e., its dimension substantially parallel to the long edge of the ski, is dependent on how the desired flattening force is to be applied, but is preferably in the range of 20 to 25 mm.

The thickness of the flattening bracket 4 is influenced by considerations of mechanical strength, flexibility, weight and cost, but is preferably in the range of 30 to 50 mm

The flattening bracket 4 may be made of any material with a suitable combination of density, cost, strength, flexibility, resilience and durability.

The track 5 may be flush with, depressed below, or raised above the surface of the bed. Of course, the structure of the track 5 will affect how the flattening bracket is slidably attached to it. Preferably, it is raised so that it need be a flattening bracket 4 may be more readily added to or removed from the track 5. A raised track 5 may be implemented as a metal, plastic or wood insert into the bed. However, a track 5 may be as simple as a router cut in a pressboard bed 2 with simple bolts and wing nuts to lock it the bracket 4 in place.

Preferably, as best shown in FIG. 5, the bed 2 is provided with the alignment rib 8, which protrudes from the top of the bed 2 and lies on the centerline of the bed 2. As shown in FIG. 1, the right side of one ski 1 and the left side of the other ski 1 are placed so they are in contact with the left and right sides of the alignment rib 8 respectively. This is to ensure proper positioning of the skis in the lateral direction. The bed 2 may be marked with a line at one end for proper positioning of the skis in the longitudinal direction.

One or more lifting shims 3 may be provided and positioned where the ski's longitudinal profile is convex downward, e.g., at a transition between a portion of the ski with rocker and a portion of the ski with camber. In the transverse dimension (perpendicular to the long dimension of the ski), the shims may be of a length similar to the flattening brackets 4, although they do not need to be as long as they do not need to engage the tracks. The shims 3 may also vary in dimension, tranversely, longitudinally and vertically. It is convenient to provide a variety of shims 3, with heights ranging e.g. form 1 mm to 2 mm.

In some embodiments, the shims 3 are separate objects that can be inserted or removed at will. In other embodiments the lifting shims 3 are slidably attached to the tracks 5, so that like the flattening brackets 4, they may be slid to desired positions.

A further consideration is that the thickness of the ski 1 is not constant along the length of the ski. Typically, the ski is about ¼ inch thick at the ends and ⅝ inch thick at the center. Since the engraving is directed to the top surface, this difference should also be accommodated by the disposition of the flattening brackets and lifting shims.

The flattening table 10 will preferably be of sufficient width to accommodate the base 2 of the flattening jig. It is preferably of a length at least as great as the sum of twice the length of the base 2, plus the length of the laser engraver unit overhanging the table 10.

The table 10 may be merely a low-friction surface on which the flattening jig is manually slid. However, it may provide a conveyor belt so that the flattening jig bearing the skis 1 can be moved underneath and past the laser engraver at a controlled and uniform speed. Or the table 10 may be movable and is moved, with the jig stationary relative to the table 10, under the a fixed laser engraver. However, you would need a way to line the table up consistently such as marks on the floor under it etc.

In the preferred embodiment (moving jig, stationary table 10 and engraver 7), there are preferably lines marked on the bed that are intended correspond to particular x and y horizontal positions of the laser.

Preferably, the laser has a peak power of 10 to 100 Watts, with 40 Watts being especially preferred. The power should be sufficient so that, with the lens geometry, there is sufficient power density at the surface of the ski to make the engraving within a reasonable time. The power density is the power divided by the spot area. Parallax tech suggests 30-70 W/mm2 for cutting thin plastic and 70-110 for decorative engraving of hard wood. If the laser output is greater than needed, the laser can be run at lower power or at a lower duty cycle (pulsed) to reduce the effective power at the imaged spot.

Preferably, the laser engraver 7 is of the type in which the workpiece (here, the flattening jig bearing the skis) is stationary and the laser optics move in the X and Y directions. However, it would be possible to modify the table 10 so as to move the workpiece under a stationary laser, or to move the workpiece along one axis and the laser along another.

Preferably, the laser engraver 7 is subject to computer numerical control (CNC). Under CNC, the laser will be positioned over a work area, the work area encompassing a selected portion of a ski or pair of skis, and will traverse that area, turning on (to burn) and off as needed in order to effectuate the design. There is a tradeoff between a larger work area (requiring a larger and probably more expensive laser engraving system, and possibly having less positioning accuracy) and a smaller work area (requiring one or more repositionings of the skis in order to complete a large design. A “scan” is herein defined as the traversal of a single work area by the laser without repositioning the laser engraver relative to the skis (or vice versa).

The laser engraver 7 preferably has a work area that is at least as wide as the design that is to be applied; otherwise, the design must be applied in lateral parts and registration errors may occur. The minimum width of the laser engraver 7 depends on whether one ski, or both skis of a pair, are to be engraved in a single run, and on the maximum width of the ski in the area that is to be engraved. Preferably, the laser engraver 7 has a work area that is at least as wide in the dimension corresponding to the lateral dimension of the ski as the width of the ski, and more preferably at least as wide as the combined width of a pair of skis and the alignment ridge separating them. If a design 9 is to be applied to the tips or tails of a pair of skis, the relevant lateral dimension is from the outside edge of one ski to the outside edge of the other ski, at the widest part of the portion to which the design 9 is applied, with the skis laid against the ridge 8. Preferably, the lateral dimension of the work area is at least 9 inches, more preferably at least 12 inches.

The other dimension of the work area, corresponding to the longitudinal dimension of the ski 1, is preferably the larger dimension. Skis vary in length from about 115-200 cm. However, the design to be engraved will typically be applied to only a portion of the length. The greater the longitudinal dimension of the work area, the fewer ‘scans” are needed to complete a “long” design. Preferably, the longitudinal dimension of the work area is at least 14 inches, more preferably at least 18 inches. It is of course advantageous to adopt a design that will be completed in a single “scan”.

Typically, the laser will be used in conjunction with a lens system of one or more lenses to reduce the diameter of the beam at the working distance. A narrow laser beam permits greater precision in drawing, but requires more burns to cover the same area.

M² (beam propagation factor) is a measure (ISO Standard 11146) of how perfect the laser beam is (how close to TEM₀₀, ie., a perfect Gaussian profile for beam intensity relative to distance from optical axis) and a value of 1.0 indicates perfection. For real lasers, it will be greater than unity. For low power lasers, it is possible to achieve a value of M² close to unity. However, there is a tradeoff between the cost of the laser tube and the value of M². Preferably, M² is not more than 1.2 and more preferably is not more than 1.1.

The laser beam diameter varies with the distance from the source, the beam having, along the optical axis, an “hourglass” shape. The narrowest portion of this shape is called the beam waist, and the beam waist radius wₒ is defined as the radius such that the points at that distance from the optical axis have an intensity which is 1/e² (0.135) times the peak intensity (at the optical axis). If the laser is not optically coupled to a lens, then it is likely that the beam waist will be inside the laser tube or very close to the output end.

The half angle divergence (angle between the divergent ray and the optical axis) from the waist radius for a diffraction limited ideal beam is the wavelength λ divided by the product of pi and the beam waste radius wₒ; the real half angle divergence is the product of M² and the ideal divergence. The full angle (width) divergence is of course twice the half angle divergence.

The Gaussian beam propagation formula may be used to calculate beam radius w(z) at any distance z along the optical axis from the beam waist for a laser beam propagating in free space (air or vacuum):

w(z)=wₒ*(M²+M²*((λ*z)/(π*wₒ²)²)^{0.5}

In the far field (large z), this can be approximated by a linear equation

w(z)=M²*((λ*z)/(π*wₒ)).

At z=Rayleigh length (π*wₒ²/(λ*M²)) from the beam waist, the beam radius is 1.414*wₒ. There are two such points, before and after the beam waist, and the distance between them (twice the Rayleigh length) is called the confocal parameter or depth of focus of the beam.

The purpose of coupling a lens (system) to a laser is to minimize beam diameter over a particular range of distances. Effectively, the beam waist may be shifted to the focal point of the lens. For a focused laser beam, the diameter of the beam at the focal point (spot diameter) is proportional to the focal length of the lens (system) and to the wavelength, and inversely proportional to the diameter of the laser beam at the point that it enters the lens. This spot diameter (mm) equals approximately 1.27*focal length*wavelength*M²/beam diameter at lens entry, 1.27 being 4/pi. The laser is preferably a carbon dioxide laser with an emission wavelength of about 10.6 microns (thus 1.27*wavelength˜0.013 mm). It will be understood that the actual emission wavelength may vary from unit to unit, e.g., from 10.2-10.8 microns, or in particular from 10.57-10.63 microns.

Laser engraving systems typically provide a standard lens with a focal length of about 2″ (50.8 mm) and optional lens covering the focal length range of 1.5 to 5 inches.

For a focused laser beam, the depth of field (focus) is defined as the optical axis range along which the diameter of the beam is no more than 1.414 times the minimum spot diameter (the diameter at the nominal focal point). DOF (mm) is 2.54*wavelength*(f/D)²/M² where D is the beam diameter at lens entry and f is the focal length of the lens (system), 2.54 being 8/pi. For the stated wavelength of 10.6 microns, 2.54*wavelength is 0.027 mm.

For a 10.6 micron carbon dioxide laser with a beam diameter of 7 mm, and M²=1, lens focal lengths of 12.7-152 mm will give spot sizes at focal point of 23-290 microns and depths of field of 86 to 12,600 microns, respectively.

Ideally, the top surface of the clamped skis 1 would be perfectly flat and horizontal. Practically speaking, some vertical variation in the height of the top surface over the laser engraver's work area is acceptable. The flattening brackets 4 and lifting shims 3 are adjusted until the vertical variation over the work area is reduced to an acceptable level. The flatness achieved is limited by the accuracy with which deviations from flatness can be detected. The flatness may be judged by eye if a straight edge is laid on top of and parallel with the long dimension of the ski, by noting the gap between the top surface of the clamped ski and the straight edge. It is also possible to use a surface flatness gage.

Preferably, the variation in the height of the top surface of the ski 1 when flattened for engraving, over the laser engraver work area, is not more than 1 mm, and more preferably not more than 0.5 mm. Note that Epilog, a laser engraver manufacturer, advises that the table flatness tolerance for its systems is 0.02 inches (0.54 mm). Desirably, when the design 9 is greater in length than the length of the work area, these preferences apply to the entire area over which the design is to be applied. However, since a larger design must be engraved in a plurality of “scans”, it is possible to adjust the flattening brackets and/or lifting shims between scans so as to achieve the desired flatness just over the scanned area.

It may be helpful to compare the height variation over the work area with the depth of focus (DOF) of the laser engraver 7. A laser engraver 7 is typically focused on the top surface of the workpiece. Ideally, since the top surface varies slightly in height, the laser will be focused so as to correspond to the average height of the topsheet in the area to be scanned, so as to take maximum advantage of the depth of focus—which extends above and below the focal point. If so, then preferably the height variation over the area to be engraved in the current scan is less than the DOF. But it is not necessary that this average height be formally measured.

That said, the height variation may exceed the DOF if the user can tolerate a greater spread of the beam at the extreme height values than the 1.414 times minimum beam diameter assumed by the definition of DOF.

The burn depth itself of course must be less than the thickness of the top sheet of the ski 1, and in rendering a grayscale image, will vary with the grayscale level. For a top sheet of about 0.6 mm thickness, a preferred maximum burn depth would be about 0.4 mm. Hence, the height variation is more preferably less than DOF less the maximum burn depth.

Images can be engraved in raster (individual pulses corresponding to pixels) or vector (image is interpreted as a series of paths and the laser is on as it moves along a path and off as it moves from where one path ends and the next begins). Typical resolutions are 150-1200 dpi. At high resolution there may be overlap of the pixels because the laser spot diameter is greater thROuan the dot pitch.

One laser engraving system which may be used is the 5th generation H-Series 20×12 Desktop CO2 laser (Full Spectrum Laser, 6216 S Sandhill Rd. Las Vegas, Nev. 89120). This has a 20×12 inch (508×304.88 mm) engraving area. (The Full Spectrum 4th generation 40 W Hobby CO2 laser engraver is similar but the maximum engravable area is 9.5 inches by 14.5 inches.) The standard CO2 laser tube for this engraver is 40 W, but it can be equipped with a 45 W or 90 W tube; the emission wavelength is 10.6 microns. The standard lens is nominally “(50.8 mm) focal length (the manual for the 4th generation 40 W Hobby CO2 Laser Engraver page 15 equates 2 inches with 55 mm, which would be 2.17″) and is intended for cutting up to ¼″ and engraving details down to around 8 pt fonts. Optional lens are available with shorter focal lengths (1.5″) are available—these offer a smaller minimum spot size but spread out more quickly beyond the focus. Optional lens with longer focal lengths (2.5″, 5″) are available to provide straighter cuts. It may be assumed that the diameter of the beam as it enters the lens lies in-between the diameter at laser output (5 mm) and the physical diameter of the lens (20 mm). Since the output wavelength is 10.6 microns (outside the visible range), the system also includes an alignment laser (visible red diode laser). The fifth generation model has an integrated beam combiner to simplify beam alignment, i.e., the red beam is aligned with the invisible (infrared) beam.

The manufacturer recommends that the control software be set for 250×250 dpi for most applications, and states that text as small as 4 pt can be engraved at 500 dpi. Engraving at 1000 dpi is possible. It is stated that the focused beam spot size is 0.002-0.0005 in (0.0508-0.127 mm) and that there will be pixel overlap at higher dpi settings. With the intermediate value o f 0.0035 inches, the DOF should be 1.26 mm for M2=1 and 0.88 for M2=1.2.

Another laser engraving system of interest is the Epilog Mini 18 with 40 W laser. This also has a 12 by 18 inch work area. According to the manufacturer, the full width divergence of the laser beam is 7.5 mrad. The standard lens has a nominal 2 inch (50.8 mm) focal length and physically is about 0.75 inches diameter and 0.125 inches thick. The accuracy of the laser system is +/−0.01 inches, and the repeatability is +/−0.0005 inches. Resolution is 75-1200 dpi.

The FAQ says that the measured spot size (with the standard lens) is 0.003″-0.005″. The Epilog Knowledge Base “Focus Lens 101” advises that the laser output is 0.24 inches in diameter, and that the lenses produces the following spot sizes: 1.5 inch focal length lens, 0.003 to 0.0065 inch spot diameter spot; and 2 inch lens, 0.004 to 0.007 inch (0.0762-0.127 mm) spot diameter. Epilog has stated that the depth of focus for the 2″ lens is 0.1 inches (2.54 mm).

Other carbon dioxide laser tubes are known in the art. For example, the Synrad Series 48 laser tubes of 10-50 W have a diameter at the beam waist of 3.5 mm and a full width beam divergence of 4 millirads, with M2 of 1.2.

Top Sheet. Preferably, the top sheet is a bamboo veneer. However, any material conventionally used as the top sheet for a ski that is suitable for laser engraving may be used. Laser engraving. The customer may provide custom art files or select from a palette of art files provided by the factory.

The laser engraving may but need not be completed in a single pass. Rather, graphics may be applied in e.g. sections of about eighteen inches apiece (or whatever is the engraving “window” of the laser) and the flattening brackets and lifting shims adjusted if desired to optimize the engraving of each separate section.

Finishing. Preferably, after laser engraving, a sealant is applied. A preferred sealant is urethane. The sealant may be hand painted on, or otherwise applied, and then allowed to dry, such as for 24 hours.

While the jig of the present invention is primarily intended to flatten a ski for laser engraving of the top sheet, it may also be used to flatten it for inkjet color printing. The topsheet may be bleached white to provide a better background for printing.

We hereby claim:

1. A flattening jig for flattening the top surface of skis which comprises a bed for resting a ski or pair of skis, at least two flattening brackets for applying a downward force for flattening up-flexed portions of the ski, and at least one pair of tracks in or on said bed for slidably positioning the brackets at different points along the length of the skis.

2. A flattening kit for flattening the top surface of a ski or pair of skis which comprises the flattening jig of claim 1, and one or more lifting shims whose positions along the length of the ski can be adjusted as needed, for applying an upward force for flattening down-flexed portions of the ski.

3. A method of laser engraving the top surface of a ski or pair of skis which comprises flattening a ski or pair of ski sin a flattening jig according to claim 1 by adjusting the position of two or more flattening brackets on top of the skis and optionally inserting one or more lifting shims underneath the skis, whereby the vertical variation in the height of the top surface of the ski over the portion of the top surface that is to be laser engraved is reduced to a level that is suitable for laser engraving, and subjecting the flattened top surface of the ski or skis to laser engraving.

4. A production and inventory management system for skis which are custom decorated with laser engraving which comprises a) manufacturing blank skis in a plurality of sizes, so dimensioned so that most customers interested in customized skis would find a suitable size, and eliminating any defective blanks; and b) laser engraving the topsheet (e.g. bamboo veneer) of each ski or pair of skis essentially according to the design requested by the customer.

5. A production and inventory management system for skis which are custom decorated with laser engraving which comprises a) manufacturing blank skis in a plurality of sizes, so dimensioned so that most customers interested in customized skis would find a suitable size, and eliminating any defective blanks; and) laser engraving the topsheet (e.g. bamboo veneer) of each ski or pair of skis essentially according to the design requested by the customer by the method of claim 3.

6. The flattening jig of claim 1, wherein said bed comprises a longitudinal rib means for aligning each ski of a pair of skis on said bed.
